(19) United States
(12) Patent Application Publication
(10) Pub. No.: US 2013/0060417 A1
(43) Pub. Date: Mar. 7, 2013

(54) TURBO-CHARGER BEARING MONITOR

(71) Applicants: Leo P Oriet, Rochester Hills, MI (US); Jules Cazabon, Staples (CA)

(72) Inventors: Leo P Oriet, Rochester Hills, MI (US); Jules Cazabon, Staples (CA)

(73) Assignee: Navistar Canada, Inc., Lisle, IL (US)

(21) Appl. No.: 13/697,628

(22) PCT Filed: May 18, 2010
(86) PCT No.: PCT/US10/35180

§ 371 Date: Nov. 13, 2012

(51) Int. Cl. G06F 17/00

(52) U.S. Cl. 701/32.7; 701/33.9; 702/34

(57) ABSTRACT

Turbocharger operational condition is monitored using vibration and temperature sensors to project probable bearing failure. Baseline or nominal vibration levels and heat generation are established under conditions when bearing condition can be taken with confidence to be close to nominal. Departure in operating temperature and vibration at a threshold level from baseline operational condition is taken as an indication of probable failure.

### BACKGROUND

1. Technical Field

The technical field relates generally to motor vehicle diagnostics and more specifically to monitoring of turbocharger condition.

2. Description of the Problem

Contemporary turbochargers used with internal combustion engines, particularly diesel cycle engines, are part of a complex and air integrated induction system operating in a demanding environment. The turbocharger includes an exhaust turbine, which rotates in response to exhaust gas discharged into the turbine, an axial (or alternatively, and more rarely, a centrifugal compressor) driven by the turbine to pump intake air into the engine's cylinders. The turbocharger frequently operates with an exhaust gas recirculation system, which diverts some exhaust air back to the air induction system. Exhaust gas recirculation raises the operating temperature of the turbocharger increasing stress on the system. The turbocharger itself may have low and high compression stages and an inter-cooler between the stages to extract heat and reinforce the air compression process. In sum, the turbocharger is a relatively complex and potentially expensive piece of machinery.

Turbochargers often operate at high angular velocities, which can easily exceed 100,000 rpm. The bearings should provide for smooth turning of the turbine, the compressor(s) and the connecting shaft. Bearing failure, particularly at high speeds, can result in extensive damage of the turbocharger, and possibly to the engine with which it is used. Bearing failure, particularly that associated with flaking resulting from early signs of fatigue is associated with increasing vibration and eventually the generation of heat. Remaining bearing life can be predicted from vibration peak levels and out of norm heat buildup during operation.

### SUMMARY

A turbocharger is monitored for its operational condition, including condition of its internal bearings, using externally mounted vibration and temperature sensors. In one embodiment the sensors are mounted to a turbocharger housing and the data is coupled to a vehicle electronic control system using a wireless link. Baseline or nominal vibration levels and heat generation are established under conditions when bearing condition can be taken with confidence to be close to nominal, such as immediately following installation. Departure in operating temperature and vibration at a threshold level from baseline operational condition is taken as an indication of probable failure at a predicted point in the future. The selected threshold level allows for normal vehicle operation to reach a maintenance station.

### BRIEF DESCRIPTION OF THE DRAWINGS

FIG. 1 is a schematic illustration of a turbocharger illustrating possible locations for vibration and temperature sensors.

FIG. 2 is a schematic drawing of the control system for the monitoring turbocharger bearing condition.

### DETAILED DESCRIPTION

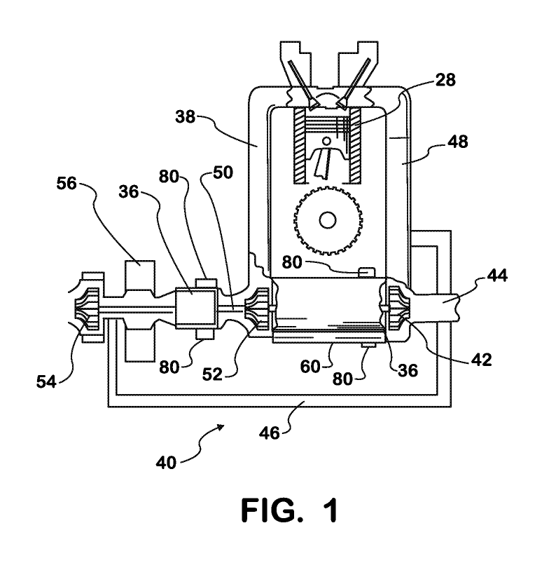

FIG. 1 illustrates a turbocharger 40 configured to boost intake pressure to an internal combustion engine 28. Turbocharger 40 includes an exhaust turbine 42 positioned at the discharge of an exhaust manifold 48 leading to an exhaust pipe 44. The exhaust turbine 42 is mechanically or hydraulically linked by a suitable coupling, represented as a shaft 50, to a high pressure stage axial compressor 52 positioned proximate to the intake manifold 38 and to a low pressure stage axial compressor 54 located further upstream. The coupling may include suitable gearing to establish operating speeds for the low and high pressure stage axial compressors 54, 52. Shaft 50, or its equivalent coupling, the exhaust turbine 42, the high pressure stage axial compressor 52 and the low pressure stage axial compressor 54 are supported for rotation by internal bearings (not shown) mounted in bearing blocks 36. The bearings are subject to deterioration and failure over time, however a time or distance to failure can be projected from vibration or heat generated by the internal bearings during operation.

Internal combustion engine 28 may be realized as a diesel engine and be equipped with an exhaust gas recirculation system 46 for emission control. Exhaust gas recirculation system 46 returns a portion of exhaust gas discharged into an air induction system. The exhaust gas carries heat into the air induction system further raising the induction system's operating temperature. An intercooler 56 may be disposed between the low pressure stage axial compressor 54 and outlet from the exhaust gas recirculation system 46 on one side and the high pressure stage axial compressor 52 on the other to extract some heat to reduce air temperature and thereby increase induction air density. The exhaust turbine 42, low and high pressure stage axial compressors 54, 52, shaft 50 and bearing blocks 36 are installed in a turbocharger housing 60. Bearings are braced in bearing blocks 36 against the turbocharger housing 60. Vibration and some of the heat generated by the bearings is communicated to the turbocharger housing 60 through the bearing blocks 36.

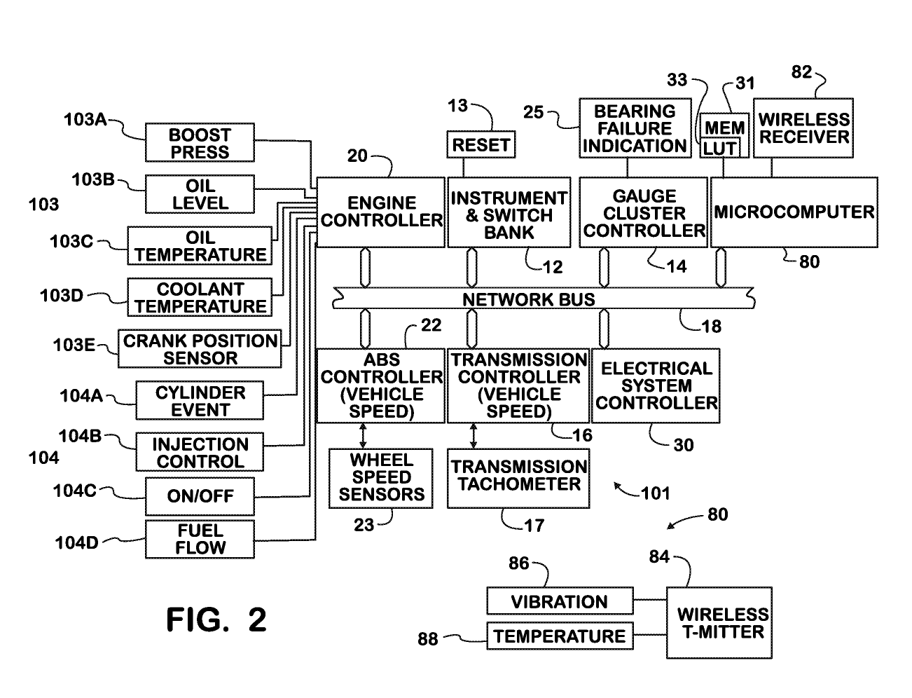

Wireless sensor assemblies 80 including vibration sensors 86, temperature sensors 88 and wireless transmitters 84 (shown in FIG. 2) are attached to the turbocharger housing 60, usually in close proximity on the opposite face of turbocharger housing 60 from points where the blocks are braced against the housing. Vibration sensors 86 and temperature sensors 88 may be connected to battery powered wireless transmitters 84 which transmit turbocharger housing 60 vibration and surface temperature, which are related to vibration and heat generated by the bearings. Alternatively, the sensors may operate on power transmitted by radio wave to the sensors by a vehicle mounted transmitter or developed by an infrared sensitive photovoltaic system. Changes in vibration are strongly related to changes in bearing condition. Changes in operating temperature may stem from other causes, such as engine operating temperature or intercooler fouling. Heat distribution on the turbocharger housing 60 may be of interest to ongoing empirical analysis.

FIG. 2 illustrates a vehicle controller area network (CAN) 101 including controllers and sources of data relating to engine and turbocharger 40 operation. Data processing facilities are provided for monitoring turbocharger housing 60 temperature and vibration and relating the data to condition of the bearings. Any one of several data processing facilities may be used, depending potentially on the sophistication of the algorithm to be used. These facilities include an engine controller 20, an electrical system controller 30 and a microcomputer 26. For purposes of this disclosure, the microcomputer 26 is illustrated as handling analysis of data relating to turbocharger 40 condition. Engine controller 20, instrument and switch bank 12, gauge cluster 14, anti-lock brake system controller 22, transmission controller 16, microcomputer 26 and electrical system controller 30 all communicate over data link 18. At least one controller is presumed to maintain a real time clock. A wireless receiver 82 is connected to microcomputer 26 for receiving data from wireless sensors on the vehicle including wireless sensor assemblies 80. Absence of a signal may result in a sensor failure indication on display panel 25. Remote sensing of turbocharger 40 condition may be implemented using remote temperature and reflected radiation Doppler shift sensing. In such cases wireless transmission and reception of signals may more readily be dispensed with.

Engine controller 20 is connected to group 103 of engine sensors 103A-E, which include an intake manifold 38 boost pressure sensor 103A, an oil level sensor 103B, an oil temperature sensor 103C, a coolant temperature sensor 103D and a crank position sensor 103E.

Control actuator group 104 includes controllers and counters for events under the control of engine controller 20. An ON/OFF controller 104C indicates whether the engine 19 is running Engine controller 20 will provide control signals to injector control 104B. Timing information for the injector control signals of course requires piston position information, which is typically derived from crankshaft position. This information comes from a crankshaft position sensor 103E. Engine controller 20 also has control over fuel flow 104D and a counter tracking cylinder ignition events 104A.

The vehicle operator is to be provided a distance estimate until possible failure of the bearings of turbocharger 40. The distance estimate may be made dependent upon average vehicle operating speeds and consequent loading of the turbocharger 40. Vehicle speed functions complementary to this operation may be combined with a vehicle's anti-lock brake system (ABS) controller 22, which has wheel speed sensors 23 associated with each of the vehicle's wheels. Wheel speed signals may be combined to generate velocity and distance traveled data. Vehicle speed and distance traveled may alternatively be measured by a transmission tachometer 17. The tachometer signal may be processed with transmission controller 16 by the engine controller 20, which receives the signal over public data link (bus) 18 enabling determination of vehicle speed, and its integral, distance traveled. Typically a prospective failure is indicated when peak to peak vibration increases by a preset percentage over baseline or nominal levels, for example 5%. At the selected level of change there should be a reasonable predicted distance to failure that will allow the vehicle operator to drive the vehicle to a maintenance station. Compensated temperature readings above nominal levels may be taken as an independent indicator of developing turbocharger damage. The vibration levels, both nominal and currently monitored, will usually be taken at the same vehicle speed, for example, in a long distance truck at highway speeds.

Repair of the turbocharger 40 may noted by service personal using a reset input 13. Baseline vibration and heat generation data may be collected an initial operational period of the vehicle following replacement of the bearings. Absent factory data the collected baseline data may be taken as nominal for a given turbocharger 40 in service conditions, and estimates of remaining service life made based on deviation of temperature and vibration from those observed during the initial operational period. The initial operational period may be a predetermined distance, and the expiration of it will be determined by data from the ABS controller 22 or the transmission controller 16. The initialization period may be extended to assure measurement of nominal or baseline temperature and vibration at highway speeds under normal load conditions. That is, fuel flow and ignition events, should be consistent with level road operation.

The reset input 13 may be handled a number of ways. They may be coupled through instrument and switch bank controller 12 to data link 18 as illustrated. For example, a service technician may use a handheld device or personal computer interface to the data link 18 to enter service data.

A display panel 25 (which may be a multi-purpose display) under the control of gauge cluster controller 14 may be used to indicate to an operator the distance and date currently estimated for the service life of turbocharger 40. The estimated service life algorithm may be represented by look up tables (LUT) 33 stored in memory 31 accessed by current vibration and compensated heat measurements. Because temperature of the turbocharger housing 60 may vary with operational temperature of the internal combustion engine 28 oil and coolant temperature may be used to derive a compensated turbocharger temperature reading.

What is claimed is:

1. A system for monitoring operational condition of a turbocharger installed on a vehicle from an external housing for the turbocharger, the system comprising:
at least a first vibration sensor for the external housing;
means for defining a nominal operational vibration level; and
a data processing facility for comparing the nominal operational vibration level with vibration readings generated by the at least first vibration sensor and indicating departure at a threshold level from the nominal operational vibration level.

2. A system as claimed in claim 1, further comprising:
the means for defining a nominal operational vibration level including a reset input for communicating with the data processing facility; and
the data processing facility being programmed to generate a baseline or nominal operational vibration level for the turbocharger housing during a limited travel distance for the vehicle.

3. A system as claimed in claim 2, further comprising:
at least a first temperature sensor for the external housing; and
the data processing facility further providing for comparing turbocharger housing temperature with a nominal level and indicating departure at a threshold level from the nominal level.

4. A system as claimed in claim 3, further comprising:
the data processing facility providing for setting baseline or nominal vibration levels and heat generation levels under conditions when bearing condition can be taken with confidence to be close to nominal.

5. A system as claimed in claim 3, further comprising:
the vibration sensor and temperature sensor being installed on the turbocharger housing; and
a wireless link being provided to communicate data and status from the vibration and temperature sensors to the data processing facility.

6. A system as claimed in claim 5, further comprising:
a plurality of temperature sensors and vibration sensors distributed on the turbocharger housing.

7. An internal combustion engine monitoring system comprising:
at least a first vibration sensor for an engine turbocharger;
means for defining a nominal operational vibration level for the turbocharger; and
a data processing facility for comparing the nominal operational vibration level with vibration readings generated by the at least first vibration sensor and indicating departure at a threshold level from the nominal operational vibration level.

8. A system as claimed in claim 7, further comprising:
a controller area network including data processing facilities for defining a nominal operational vibration level including a reset input for communicating with the data processing facility; and
the data processing facility being programmed to generate a baseline or nominal operational vibration level for the turbocharger housing during a limited travel distance for the vehicle following placing of the turbocharger into service or repair of the bearings of the turbocharger.

9. A system as claimed in claim 8, further comprising:
at least a first temperature sensor for an engine turbocharger; and
a wireless link between the vibration and temperature sensors and the controller area network.

10. A method of monitoring bearing condition for a turbocharger, the method comprising the steps of:
determining a nominal peak to peak vibration levels and heat generation for a turbocharger at predetermined engine operating conditions;
monitoring turbocharger peak to peak vibration levels and heat generation during engine operation; and
indicating expected failure when peak to peak vibration levels or heat generation exceed nominal peak to peak vibration levels and heat generation levels during engine operation at the predetermined engine operating conditions.
